(19) United States
(12) Patent Application Publication
(10) Pub. No.: US 2006/0268489 A1
(43) Pub. Date: Nov. 30, 2006

(54) Static electricity and electric shock protection apparatus for mobile terminal

(75) Inventor: Joo Hun Sung, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/441,511

(22) Filed: May 26, 2006

(30) Foreign Application Priority Data
May 27, 2005 (KR) 2005-45054

(51) Int. Cl. H02H 1/00

(52) U.S. Cl. 361/212

(57) ABSTRACT

Disclosed is a static electricity and electric shock protection apparatus for a mobile terminal including a body housing, in which at least a part of the body housing is made of a conductive material. The apparatus includes a grounding unit of a printed circuit board, a virtual grounding pad formed on the printed circuit board, and a diode bridge circuit connected between the grounding unit of the printed circuit board and the virtual grounding pad. In order to improve the protection capability, it is possible to attach an electromagnetic-wave absorber to the diode bridge circuit. When the mobile terminal is mounted on a charger, static electricity applied to the virtual grounding pad through the body housing of the mobile terminal is discharged to a ground for the charger through the diode bridge circuit and the grounding unit of a printed circuit board. In the state in which the mobile terminal is mounted on a charger, when a voltage caused by a leakage current exceeds a withstanding voltage of a diode contained in the diode bridge circuit, a discharge path is formed along the diode bridge circuit, the grounding unit of the printed circuit board, and a ground for the charger.

### PRIORITY

This application claims the benefit under 35 U.S.C. 119(a) of an application entitled “Static Electricity And Electric Shock Protection Apparatus For Mobile Terminal” filed in the Korean Intellectual Property Office on May 27, 2005 and assigned Serial No. 2005-45054, the entire contents of which are incorporated herein by reference.

### BACKGROUND OF THE INVENTION

1. Field of the Invention

The present invention relates to a static electricity and electric shock protection apparatus for a mobile terminal including a body housing, in which a part or the entirety of the body housing is made of a conductive material.

2. Description of the Related Art

A mobile terminal such as a portable telephone carried by a user, is one of the many sorts of electronic devices that are located very near a person for a long period of time. Considering the convenience in carrying mobile terminals, the mobile terminals are now being manufactured to have a slimmer appearance. In order to prevent deterioration of strength due to such a slim thickness, the body housing of mobile terminals are now being made of metal (e.g. magnesium). Meanwhile, in order to make a mobile terminal's housing of metal, it is necessary to take safety precautions for protection from the danger of electric shock and static electricity. That is, when user's skin touches conductive material (such as metal or conductive plastic), an electric shock may occur, which may cause a serious injury to the user, or which may make the user uncomfortable even if the user does not suffer a serious injury.

Also, when a great electro-static discharge is generated, the mobile terminal may malfunction. Static electricity has a very high voltage of several thousands to tens of thousands of volts. Since static electricity has little electric current despite having such a very high voltage, there is almost no danger of electric shock, but it may inflict skin damage to the user. Also, since the instantaneous voltage of static electricity is very high, a fire may break out due to a spark, or a delicate electronic circuit may malfunction. For example, the delicate electronic circuit may be influenced by an electromagnetic wave generated in the course of electro-static discharge, or electronic parts may be damaged due to a high instantaneous voltage.

Static electricity may be generated by the touch of skin, charging, or other causes. Since a large discharge path is formed in the course of charging, excessive static electricity may be generated. The effect or degree of danger placed upon each person due to electric shock may differ depending on their physical characteristics or circumstances, so it is difficult to uniformly define the effect or degree of danger of an electric shock. However, when a person receives an electric shock, the degree of danger may be determined, based on the amount of electric-shock current, the duration of the electric shock, the route of electric shock, and the kind of a power supply.

The electric-shock current will not be perceived by a person when the electric-shock current has a value smaller than a threshold value, while it will be perceived by a person when the electric-shock current has a value greater than or equal to the threshold value. The threshold value is called the “minimum perception current”, which corresponds to a direct current of approximately 2 to 5 mA, or an alternating current (of a commercial frequency of 60 Hz) of approximately 0.5 to 2.0 mA. As an electric-shock current increases above the limit of the minimum perception current, pain is gradually perceived. A current causing the pain which is bearable and is not fatal, is called a “let-go current” or “high perception current”, which corresponds to an alternating current of approximately 7 to 8 mA in the case of adult men.

Therefore, when goods are manufactured, not only allowable contact voltage and current must be determined in consideration of the safety of people, but also various conditions including peripheral environments must be considered.

In addition, since protection against static electricity and the protection against electric shock are contrary to each other, one protection aspect may be degraded when goods are manufactured to improve the other protection aspect. Therefore, the development of an apparatus having a sufficient protection performance against both static electricity and electric shock is required.

### SUMMARY OF THE INVENTION

Accordingly, the present invention has been made to solve the above-mentioned problems occurring in the prior art, and the present invention provides a static electricity and electric shock protection apparatus for a mobile terminal including a body housing, in which at least a part of the body housing is made of a conductive material, by which people and the mobile terminal can be protected from electric shock and static electricity while the performance for any one protection aspect is not degraded.

To accomplish this object, in accordance with one aspect of the present invention, there is provided a static electricity and electric shock protection apparatus for a mobile terminal including a body housing, in which at least a part of the body housing is made of a conductive material, the apparatus including a grounding unit of a printed circuit board; a virtual grounding pad formed on the printed circuit board; and a diode bridge circuit connected between the grounding unit of the printed circuit board and the virtual grounding pad. In order to improve the protection capability, it is preferable to include an electromagnetic-wave absorber, which is placed on the virtual grounding pad.

When the mobile terminal is mounted on a charger, static electricity applied to the virtual grounding pad through the body housing of the mobile terminal is discharged to a ground for the charger through the diode bridge circuit and the grounding unit of a printed circuit board. In the state in which the mobile terminal is mounted on a charger, when a voltage caused by a leakage current exceeds a withstanding voltage of a diode contained in the diode bridge circuit, a discharge path is formed along the diode bridge circuit, the grounding unit of the printed circuit board, and a ground for the charger.

### BRIEF DESCRIPTION OF THE DRAWINGS

The above and other objects, features and advantages of the present invention will be more apparent from the following detailed description taken in conjunction with the accompanying drawings, in which:

FIG. 1 is a circuit diagram illustrating the construction of a static electricity and electric shock protection apparatus for a mobile terminal according to a first an embodiment of the present invention; and

FIG. 2 is a circuit diagram illustrating the construction of a static electricity and electric shock protection apparatus for a mobile terminal according to another embodiment of the present invention.

### DETAILED DESCRIPTION OF THE PREFERRED EMBODIMENT

Hereinafter, preferred embodiments of the present invention will be described with reference to the accompanying drawings. It is to be noted that the same elements are indicated with the same reference numerals throughout the drawings. In the below description, many particular items such as a detailed circuit element are shown, but these are provided only for providing the general understanding of the present invention, it will be understood by those skilled in the art that the present invention can be embodied without including these particular items. In the following description of the embodiments of the present invention, a detailed description of known functions and configurations incorporated herein will be omitted when it may obscure the subject matter of the present invention.

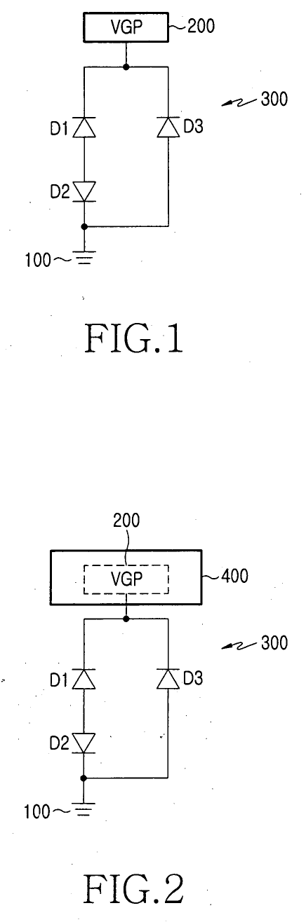

FIG. 1 is a circuit diagram illustrating the construction of a static electricity and electric shock protection apparatus for a mobile terminal according to a first embodiment of the present invention.

The static electricity and electric shock protection apparatus includes a grounding unit 100 for a printed circuit board (PCB), a virtual grounding pad (VGP) 200 located on the PCB, and a diode bridge circuit 300 connected between the PCB grounding unit 100 and the virtual grounding pad 200. Herein, the PCB represents the main PCB of the mobile terminal.

When the mobile terminal is placed in a charger (not shown), the PCB grounding unit 100 of the mobile terminal is connected to a ground for the charger. Accordingly, static electricity is applied to the virtual grounding pad 200, which is connected to a specific conductive-material part (e.g. a sliding hinge part in the case of a slide-type mobile terminal) of the body housing by using a conducting tape or the like. In this case, when the voltage caused by the static electricity increases above the withstanding voltage of diodes D1, D2 and D3, a discharge path is formed, so that the static electricity is discharged to the ground for the charger through the diode bridge circuit 300.

As described above, the diode bridge circuit 300 can efficiently discharge static electricity when the static electricity exists, while minimizing its effect on the mobile terminal. However, it is impossible to completely protect people from the danger of electric shock resulting from over-current using only the diode bridge circuit 300. That is, in the case of the construction shown in FIG. 1, an electric shock may be generated due to over-current.

FIG. 2 is a circuit diagram illustrating the construction of a static electricity and electric shock protection apparatus for a mobile terminal according to another embodiment of the present invention. The construction shown in FIG. 2 includes an electromagnetic-wave absorber in addition to the construction shown in FIG. 1.

The static electricity and electric shock protection apparatus shown in FIG. 2 includes a grounding unit 100 for a PCB, a virtual grounding pad 200 located on the PCB, a diode bridge circuit 300 connected between the PCB grounding unit 100 and the virtual grounding pad 200, and an electromagnetic-wave absorber 400 attached to the virtual grounding pad 200.

Generally, the electromagnetic-wave absorber 400 is used for radiation capability and interruption of a harmful wave. The electromagnetic-wave absorber 400 according to the present invention is used not only to form an efficient discharge path when static electricity is generated, and but is also used to prevent electric shock by interrupting an electric-shock current when static electricity is not generated.

The virtual grounding pad 200 is located on the PCB of the mobile terminal, and the electromagnetic-wave absorber 400 is located on the virtual grounding pad 200. That is, the virtual grounding pad 200 is attached to the PCB, and the electromagnetic-wave absorber 400 is attached to the virtual grounding pad 200 such that preferably the electromagnetic-wave absorber 400 covers the virtual grounding pad 200.

According to such a construction, the electromagnetic-wave absorber 400 exists between the virtual grounding pad 200 and a specific part (e.g. a sliding hinge part in the case of a slide-type mobile terminal) of the body housing of the mobile terminal. Accordingly, conducting does not occur in a normal time or when a voltage less than the withstanding voltage of diodes D1, D2 and D3 is charged. However, when the charged voltage exceeds the withstanding voltage of the diodes D1, D2 and D3 due to static electricity or a leakage current, the diodes D1, D2 and D3 may break down to be a conducting state, thereby forming a discharge path.

As described above, when the electromagnetic-wave absorber 400 is attached to the virtual grounding pad 200, it is possible to significantly reduce an electric-shock current as well as an electric-shock voltage, which will now be described with a detailed example.

When the electromagnetic-wave absorber 400 is not attached, as shown in FIG. 1, an alternating voltage detected from an implement connected to the virtual grounding pad 200 is 30 to 40 volts (in this case, a voltage detected from the PCB grounding unit 100 is 80 to 90 volts). In contrast, when the electromagnetic-wave absorber 400 is attached, as shown in FIG. 2, an alternating voltage detected from an implement connected to the virtual grounding pad 200 is only 5 to 10 volts. In addition, an electric current of 30 mA [AC] or more in the case in FIG. 1 decreases to an electric current of 3 to 5 μA [AC].

In a case in which the withstanding voltage of the diodes D1, D2 and D3 used in the diode bridge circuit 300 is approximately 300 volts, when the mobile terminal is placed in a charger to be charged, or when the terminal is connected to the ground (such as a data cable) of a power source having a voltage of less than 300 volts, the diode bridge circuit 300 interrupts the passage of an electric current, so that a voltage at a metallic implement connected to the virtual grounding pad 200 decreases to 5 to 10 volts. In this case, there is likely to be no danger of electric shock due to voltage, but actually, electric shock may occur due to a diode leakage current of approximately 3 mA [AC]. In other words, it is possible to prevent electric shock caused by a voltage, but it is impossible to prevent electric shock caused by an electric current. That is, even a low voltage may cause electric shock if there is a large amount of electric current. In the case in which the electromagnetic-wave absorber 400 is attached to the virtual grounding pad 200 as described above, when a low voltage of less than 500 volts is generated, the electromagnetic-wave absorber 400 interrupts the flow of electric current so as to form an insulation layer, thereby preventing electric shock. Also, when a high voltage of greater than 500 volts is generated, the electromagnetic-wave absorber 400 breaks down, similarly to a diode, to form a discharge path as described with reference to FIG. 1, thereby preventing components from being damaged due to static electricity.

According to the present invention as described above, although a part or the entire of the body housing of the mobile terminal is made of conductive material, a discharge path is formed to efficiently discharge static electricity, so that it is possible to prevent a person from experiencing a bad effect or uncomfortable perception and to prevent the mobile terminal from malfunctioning, resulting from static electricity or electric shock due to a leakage current.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A static electricity and electric shock protection apparatus for a mobile terminal including a body housing, in which at least a part of the body housing is made of a conductive material, the apparatus comprising:
a grounding unit of a printed circuit board;
a virtual grounding pad formed on the printed circuit board; and
a diode bridge circuit connected between the grounding unit of the printed circuit board and the virtual grounding pad.

2. The apparatus as claimed in claim 1, further comprising an electromagnetic-wave absorber which is placed on the virtual grounding pad.

3. The apparatus as claimed in claim 1, wherein, when the mobile terminal is mounted on a charger, static electricity applied to the virtual grounding pad through the body housing of the mobile terminal is discharged to a ground for the charger through the diode bridge circuit and the grounding unit of a printed circuit board.

4. The apparatus as claimed in claim 2, wherein, when the mobile terminal is mounted on a charger, static electricity applied to the virtual grounding pad through the body housing of the mobile terminal is discharged to a ground for the charger through the diode bridge circuit and the grounding unit of a printed circuit board.

5. The apparatus as claimed in claim 1, wherein, in the state in which the mobile terminal is mounted on a charger, when a voltage caused by a leakage current exceeds a withstanding voltage of a diode contained in the diode bridge circuit, a discharge path is formed along the diode bridge circuit, the grounding unit of the printed circuit board, and a ground for the charger.

6. The apparatus as claimed in claim 2, wherein, in the state in which the mobile terminal is mounted on a charger, when a voltage caused by a leakage current exceeds a with standing voltage of a diode contained in the diode bridge circuit, a discharge path is formed along the diode bridge circuit, the grounding unit of the printed circuit board, and a ground for the charger.

7. The apparatus as claimed in claim 2, wherein the electromagnetic-wave absorber is attached to the printed circuit board such that the electromagnetic-wave absorber covers the virtual grounding pad.
